(19) United States
(12) Patent Application Publication
(10) Pub. No.: US 2013/0022343 A1
(43) Pub. Date: Jan. 24, 2013

(54) CAMERA

(71) Applicant: Susumu Ozeki, Shijonawate City (JP)

(72) Inventor: Susumu Ozeki, Shijonawate City (JP)

(73) Assignee: SANYO ELECTRIC CO., LTD., Moriguchi city (JP)

(21) Appl. No.: 13/554,330

(22) Filed: Jul. 20, 2012

(30) Foreign Application Priority Data
Jul. 20, 2011 (JP) JP2011-158529

(51) Int. Cl. G03B 17/00

(52) U.S. Cl. 396/82

(57) ABSTRACT

A camera, comprising an optical system for capturing an image of a subject, in which a zoom position and a focus position are adjusted by an adjustment operation performed by a user; the camera comprising a replication information holding unit for recording and holding the zoom position and the focus position adjusted by the adjustment operation as a replication zoom position and a replication focus position respectively; and a replication assistance unit for assisting replication of the zoom position and the focus position; the replication assistance unit being configured so as to automatically adjust the focus position to the replication focus position when the zoom position is adjusted by the adjustment operation so as to substantially match the replication zoom position.

### CROSS-REFERENCE TO RELATED APPLICATIONS

This application is based upon the corresponding Japanese Patent Application No. 2011-158529, filed Jul. 20, 2011, the entire contents of which are included as reference.

### BACKGROUND OF THE INVENTION

1. Field of the Invention

The present invention relates to a camera used to capture an image of a subject.

2. Description of Related Art

Cameras used to capture an image of a subject have been in widespread use. In general, in cameras, the zoom position and focus position can be adjusted in order to allow an image to be captured in an appropriate manner. Known methods for adjusting the focus position include auto focus (may be referred to as “AF” in the present application) and manual focus (may be referred to as “MF” in the present application). In an instance of MF, the user adjusts the focus position him/herself.

There are a variety of models of cameras; one of such cameras having a manual zoom lens. In this model, the user performs a rotating operation on the zoom ring, whereby the zoom position can be adjusted. Models having a manual zoom lens are highly rated by users due to the analog feel of performing the zoom adjustment operation, an ability to perform zoom adjustment in a speedy manner, and other reasons.

Uses of cameras are diverse; e.g., in a case in which a camera is used commercially, image-capturing may be repeatedly performed under similar circumstances and conditions. In such a case, image-capturing is often repeated without any changes being made to the zoom position or the focus position. In such an instance, it is cumbersome for the user to be forced to, e.g., perform an adjustment to replicate the zoom position or the focus position when the power is switched back on after each occasion in which the power is switched off.

Therefore, in a camera, it is preferable that even when the zoom position and the focus position that have already been adjusted are temporarily lost, the zoom position and the focus position can be readily subsequently replicated. For example, it is preferable that even when the power of the camera is switched off, the zoom position and the focus position that have previously been adjusted can be readily replicated when the power of the camera is switched back on.

With circumstances of such description in view, there have been proposed, in relation to, e.g., cameras having a digital zoom lens, models in which information [representing] the zoom position and the focus position that have been previously adjusted is recorded and held, and during startup in an MF setting, this information is used to automatically replicate the zoom position and the focus position.

The circumstances mentioned above also apply to camera models having a manual zoom lens. In cameras of these models, it is also preferable that the zoom position and the focus position that have already been adjusted can be readily replicated.

In a case in which the zoom ring is used both to control the power and control the zoom (e.g., the power is switched off when the zoom ring is caused to rotate beyond the WIDE-end position), it is necessary to readjust the zoom position and the focus position each time the power is switched off. In such a case, it is particularly desirable for the zoom position and the focus position to be readily replicable.

However, the mechanism for adjusting the zoom position in models having a manual zoom lens is constructed so that the zoom position changes in coordination with the rotation of the zoom ring. Therefore, particularly in models having a manual zoom lens, it may be difficult to provide a mechanism for automatically replicating the zoom position. In cameras other than models having a manual zoom lens, if a mechanism for automatically replicating the zoom position becomes unnecessary, the configuration of the camera can be readily simplified, as other attributes can be facilitated.

### SUMMARY OF THE INVENTION

A camera according to the present invention is a camera comprising an optical system which captures an image of a subject, in which a zoom position and a focus position are adjusted by an adjustment operation performed by the user; the camera comprising a replication information holding unit which records and holds the zoom position and the focus position that have been adjusted by the adjustment operation as a replication zoom position and a replication focus position; and a replication assistance unit which assists replication of the zoom position and the focus position; the replication assistance unit being configured so as to automatically adjust the focus position to the replication focus position when the zoom position is adjusted by the adjustment operation so as to substantially match the replication zoom position.

### BRIEF DESCRIPTION OF THE DRAWINGS

The aforementioned and other objects and characteristics of the present invention will become clearer upon referencing the below description and the accompanying drawings showing the following matter regarding a preferred embodiment.

FIG. 1 is an external view of a camera according to an embodiment of the present invention as viewed from the front;

FIG. 2 is an external view of the camera according to the embodiment of the present invention as viewed from the rear;

FIG. 3 is an illustrative drawing relating to a control system of the camera according to the embodiment of the present invention;

FIG. 4 is an illustrative drawing relating to the display state of the display;

FIG. 5 is an illustrative drawing relating to the zoom ring;

FIG. 6 is a flow chart relating to a replication assistance action; and

FIG. 7 is an illustrative drawing relating to the zoom position confirmation bar.

### DETAILED DESCRIPTION OF PREFERRED EMBODIMENTS

A description will now be given for an embodiment of the present invention using a digital still camera (a format of a camera for capturing an image of a subject; hereafter simply referred to as a “camera”) as an example, with reference to the accompanying drawings.

(Camera Configuration, etc.)

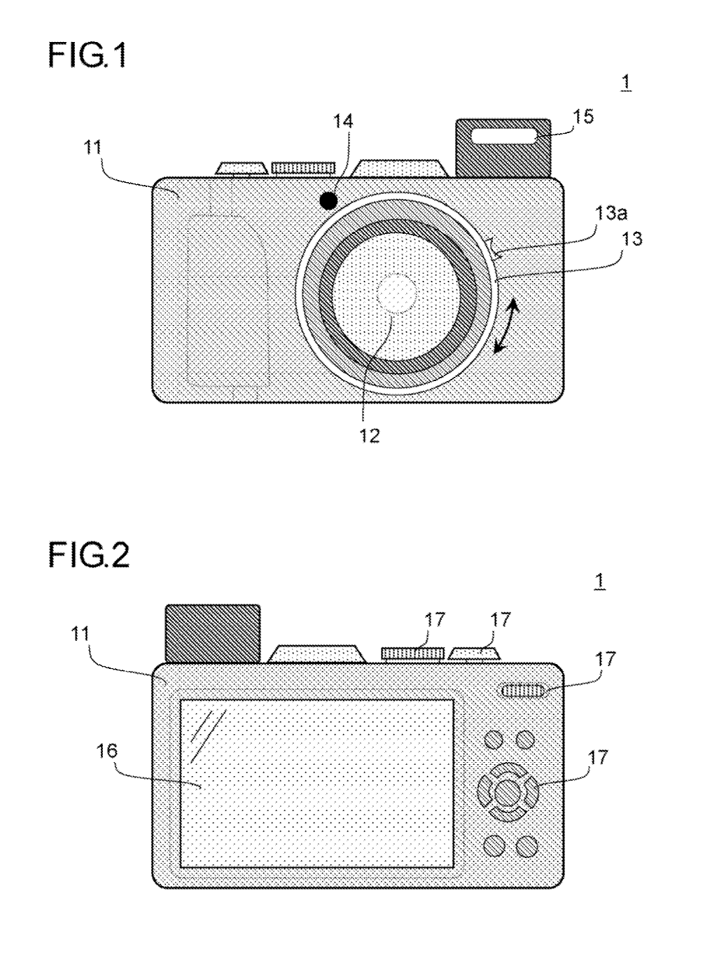

FIG. 1 is an external view of a camera according to an embodiment of the present invention as viewed from the front (a view of the front-surface side); and FIG. 2 is an external view of the camera as viewed from the rear (a view of the rear-surface side).

As shown in the drawings, the camera 1 has a configuration in which a substantially cuboid frame 11 is equipped with a lens unit 12, a zoom ring 13, an AF assistance light lamp 14, a flash light generation device 15, a display 16, operation switches 17, and other elements. The camera 1 has an optical system for capturing an image of a subject, and is assumed to be used for capturing an image of a subject in a state in which the front-surface side is facing the subject.

The lens unit 12 is formatted so as to protrude from the front surface of the frame 11 as a substantially cylindrical shape, and represents a principal portion of the optical system used for capturing an image of the subject. Also, the lens unit 12 has a zoom lens (manual zoom lens), a focus lens, and other components, and it is possible to change the zoom position or the focus position when an image is captured.

The zoom ring 13 has a substantially hollow cylindrical shape, and is provided in a format in which it is fitted in the lens unit 12 so as to form a circle that is concentric with the lens unit 12. A release button 13a used to release the lock (described in detail further below with reference to FIG. 5) is provided on an exterior side surface of the zoom ring 13. The zoom ring 13 is capable of being rotatably moved in the direction indicated by the arrow in FIG. 1 with its center axis being the axis of rotation.

The user is thereby capable of performing a rotating operation on the zoom ring 13. In other words, the zoom ring 13 constitutes rotation-type operation means operated by the user.

The zoom ring 13 is also mechanically linked to the zoom lens, and it is possible to cause the zoom ring 13 to rotate and [thereby] vary the zoom position without electrical control or other means. The user can perform a rotating operation on the zoom ring 13 (i.e., an operation of adjusting the zoom position), vary the zoom position in an analog manner, and adjust [the zoom position] to a desired state. The format of the camera 1 will be described in further detail later.

The AF assistance light lamp 14 is a lamp for emitting an AF assistance light as necessary when focusing is performed in auto focus (AF), and is provided to the front surface of the frame 11. The AF assistance light performs a role of assisting distance measurement in an instance in which, e.g., the surroundings are dark, and distance measurement in AF is difficult. The flash light generation device 15 is a built-in type light-emitting device provided to emit a flash light.

The display 16 is, e.g., a liquid crystal display (LCD) and is provided to a rear surface of the frame 11. The display 16 is used, as a monitor screen, to display a monitor image of the subject; and also to display a variety of information as described in further detail further below.

A plurality of the operation switches 17 are arranged, primarily on the rear surface and the top-surface side of the frame 11; and are operated by the user as appropriate. The operation switches 17 include a shutter button, which is pressed when a photograph is taken; a switching switch for switching the method for adjusting focus; a focus adjustment dial used to adjust the focus position in manual focus (MF); and other switches.

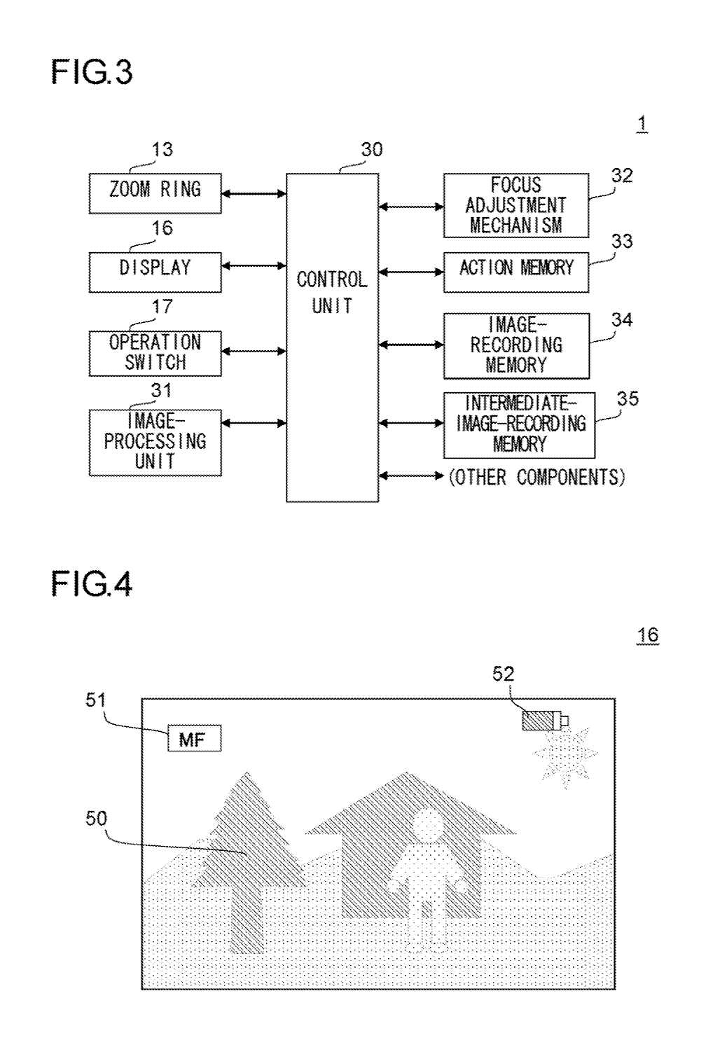

Next, a description will be given for a principal control system in the camera 1. FIG. 3 shows the principal control system in the camera 1. As shown in this drawing, the camera 1 has, in addition to the components mentioned earlier, a control unit 30, an image-processing unit 31, a focus adjustment mechanism 32, an action memory 33, an image-recording memory 34, an intermediate-image-recording memory 35, and other components.

The control unit 30 is formed from, e.g., a CPU. The control unit 30 controls each of the components so that the camera 1 is actuated in an appropriate manlier. Specifics of operation of the zoom ring 13 and the operation switches 17 are transmitted to the control unit 30, and it is possible for these specifics (i.e., the intent of the user) to be reflected in the action of the camera 1. Main actions performed by the camera 1 will be described in detail later.

The image-processing unit 31 has a sensor (CCD or CMOS) for detecting light obtained by the optical system possessed by the camera 1, performs a predetermined process on a signal detected by the sensor, and acquires the image of the subject as electronic information. The image-processing unit 31 performs a role of e.g., acquiring a video image (monitor image) of the subject captured in real-time.

The focus adjustment mechanism 32 is formed from a focus lens included in the lens unit 12, and other elements; and performs a role of making it possible to adjust the focus position. The focus adjustment mechanism 32 automatically adjusts the focus position in correspondence with the operation of a zoom lever when AF is enabled, and adjusts the focus position in accordance with an adjustment operation performed by the user using the focus adjustment dial when MF is enabled.

The focus adjustment mechanism 32 is equipped with an MF assistance function for assisting the operation of adjusting focus in MF. The MF assistance function is a function for displaying a part of the monitor image of the subject (a portion of interest when adjusting the focus position) in expansion, and facilitating the adjusting of the focus position by visual observation. [A configuration is possible in which] the MF assistance function can be switched between enabled and disabled by, e.g., operating an operation switch 17.

The action memory 33 is formed from a non-volatile memory, and stores a variety of information necessary for the action of the camera 1. The action memory 33 also performs a role of recording and storing predetermined replication information (described in detail further below).

The image-recording memory 34 is formed from a non-volatile memory, and records a photograph of the subject and similar information. The action memory 33 and the image-recording memory 34 may be a shared memory. The intermediate-image-recording memory 35 is, e.g., an SDRAM (a volatile memory), and is used to record an intermediate image (e.g., information in RAW, YUV, orJPEG format) during processing.

(Basic Action of the Camera)

Next, a description will be given for each basic action performed by the camera 1. The camera 1 performs an action of taking a photograph of the subject. More specifically, the control unit 30 stands by for the shutter button to be pressed while displaying the monitor image of the subject on the display 16.

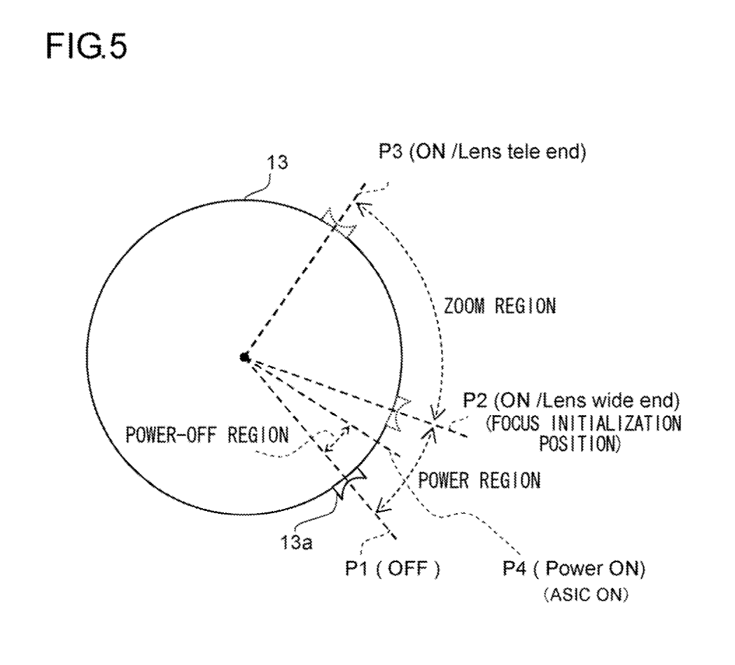

At this time, the display 16 displays the monitor image 50 of the subject on the entire screen, and simultaneously displays onscreen a focus information display 51 and a remaining battery level display 52, as shown in FIG. 4. The focus information display 51 /indicates the method of focus adjustment that is currently enabled (i.e., MF or AF), and the remaining battery level display 52 indicates the remaining battery level of a battery that supplies power to the camera 1.

The control unit 30 causes a photograph of the subject, [taken] at the timing at which the shutter button has been pressed, to be recorded in the image-recording memory 34. A similar action is subsequently repeated, and a photograph of the subject is recorded each time the shutter button is pressed.

The camera 1 is configured such that the zoom position and the power state are controlled in correspondence with a rotating operation performed by the user on the zoom ring 13. In other words, the zoom ring 13 is formatted so as to [function] both as operating means for adjusting the zoom position and operating means for switching the power state. This will be now described in further detail with reference to FIG. 5.

FIG. 5 schematically represents the zoom ring 13. Each of P1 through P4 in the drawing indicates a position of rotation of the zoom ring 13 (defined by the position of the release button 13a for ease of description). A region within which the zoom ring 13 can be moved is a region in which the position of rotation falls between P1 and P3.

With regards to the positions of rotation, a region between P1 and P2 is a “power region”, and a region between P2 and P3 is a “zoom region”. Thus, the zoom region and the power region are provided adjacent to each other in the region within which the zoom ring 13 can be moved in the direction of rotation. P4 is further provided in the region between P1 and P2, and a region between P1 and P4 is a “power-off region” used to designate the power of the camera 1 as being off. Thus, the power-off region is provided within the power region.

The power region is a region for switching the camera 1 between power-off and power-on [states]. Specifically, when an operation is performed to move the position of rotation from the zoom-region side to P4, it is considered that a power-off command has been issued. The power-off command is sent to the control unit 30, and the camera 1 is controlled so as to be in a power-off state. While the position of rotation is in the power-off region, the camera 1 maintains the power-off state. When an operation is performed to move the position of rotation from the power-off-region side to P4, it is considered that a power-on command has been issued. The power-on command is sent to the control unit 30, and the camera 1 is controlled so as to be in a power-on state.

The zoom region is a region for causing the camera 1 to initialize the focus position and designate the zoom position between a WIDE end and a TELE end of the lens. Specifically, when an operation is performed to move the position of rotation from the power-region side to P2 (one end of the zoom region), it is considered that a command has been issued to initialize the focus position. The command for initializing the focus position is sent to the control unit 30, and initialization of the focus position is performed in the camera 1. While the position of rotation is in the zoom region, the camera 1 maintains the power-on state.

While the position of rotation is in the zoom region, the zoom position and the position of rotation correspond one-to-one; as the position of rotation approaches P3, the zoom position approaches the TELE side of the lens. When the position of rotation is at position P2, the zoom position is at the WIDE end, and when the position of rotation is at position P3, the zoom position is at the TELE end.

At positions of rotation P1 and P2, a lock blocking the rotation of the zoom ring 13 is engaged in order to prevent the zoom ring 13 from inadvertently rotating. This lock is released by pressing the release button 13a. In an instance in which the zoom ring 13 is to be rotated from position P1, and in an instance in which the zoom ring 13 is to be rotated over position P2, the user performs an operation of rotating the zoom ring 13 while pressing the release button 13a.

The position of rotation of the zoom ring 13 is transmitted to the control unit 30 in real time as an analog digital (AD) value. The control unit 30 can thereby identify the zoom position in real-time. The AD value is a value that varies as a linear function with regards to the relationship with the zoom position.

The power-on state is a state in which power is supplied to each of the components so that normal actions of the camera 1 (e.g., monitoring the subject or taking a photograph) are possible, and the power-off state is a state in which supply of power to a circuit and other components used for monitoring the subject or taking a photograph is reduced, and as a result, power consumption is reduced. When in use, the camera 1 is set to the power-on state, and when not in use, [the camera 1] is set to the power-off state. With regards to the power-off state, as long as the supply of power is reduced compared to that in the power-on state, and power consumption is reduced, there are no particular limitations on the specific format.

In the camera 1, the enabled method for focus adjustment is switched between MF and AF in correspondence with the operation of the switching switch by the user. As mentioned earlier, the focus adjustment mechanism 32 allows the focus position to be adjusted according to the currently enabled method.

Also, the camera 1 is [configured] to perform, in addition to the basic actions mentioned above, a replication information recording action for recording replication information, and a replication assistance action for assisting the replication of the zoom position and the like. These actions will now be described in sequence.

(Replication Information Recording Action)

The replication information recording action is an action for recording and updating, each time the zoom position or the focus position is adjusted in a situation in which MF is enabled, the state (position) after adjustment, as a replication zoom position or a replication focus position, in the action memory 33. The replication zoom position is recorded as, e.g., an AD value.

The action memory 33 continues to hold the recorded replication zoom position and replication focus position (may be hereafter referred to together as “replication information”) irrespective of the power state of the camera 1 (i.e., even when the power-off state is present). Therefore, even when the power of the camera 1 is [switched] off and then [switched] back on, the replication information is held in the action memory 33.

Each time the replication information recording action is performed, the replication information held in the action memory 33 is updated to the latest replication information. Specifically, in the camera 1, each time a zoom position adjustment operation is performed to adjust the zoom position, the replication zoom position is recorded and updated; and each time a focus position adjustment operation is performed to adjust the focus position, the replication focus position is recorded and updated.

The latest of the zoom positions or the focus positions that have been previously adjusted when kW is enabled is thereby recorded and held as replication information. The replication information that is recorded and held is utilized in the replication assistance action described below.

As an example of a modification of the present embodiment, the replication information recording action may also be performed irrespective of which of MF and AF is enabled. Also, the recording and updating of the replication focus position may be performed only when the focus position is adjusted using the MF assistance function.

(Replication Assistance Action)

The replication assistance action is launched (1) when the method of focus adjustment is switched from AF to MF, and (2) when the power state is switched from power-off to power-on, and the method of focus adjustment is MF.

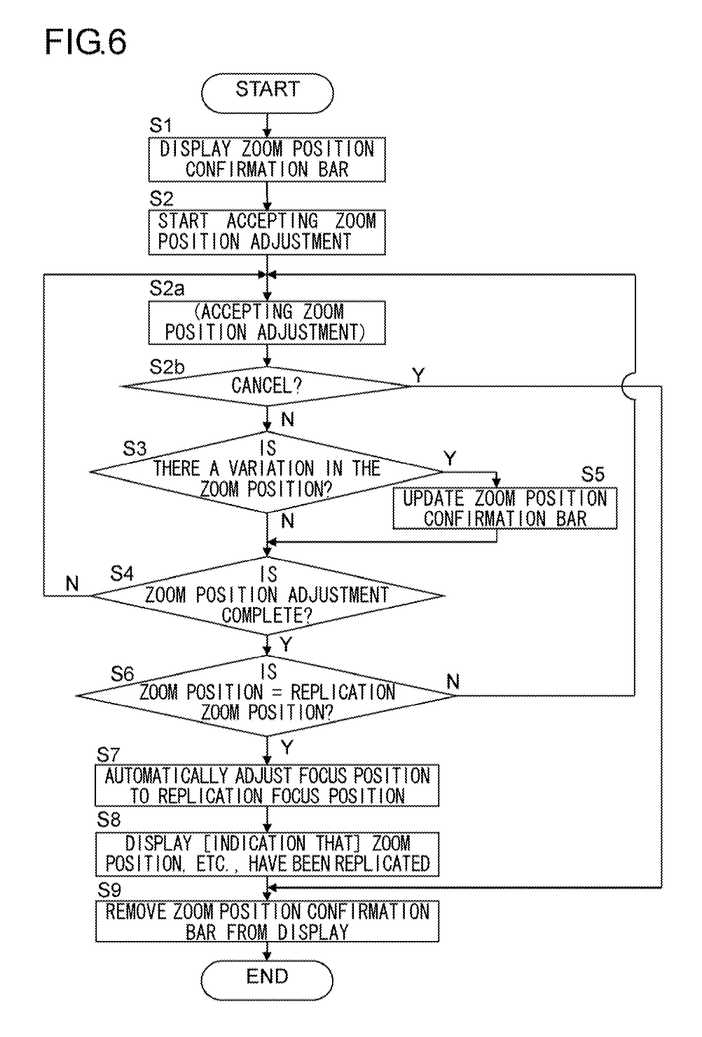

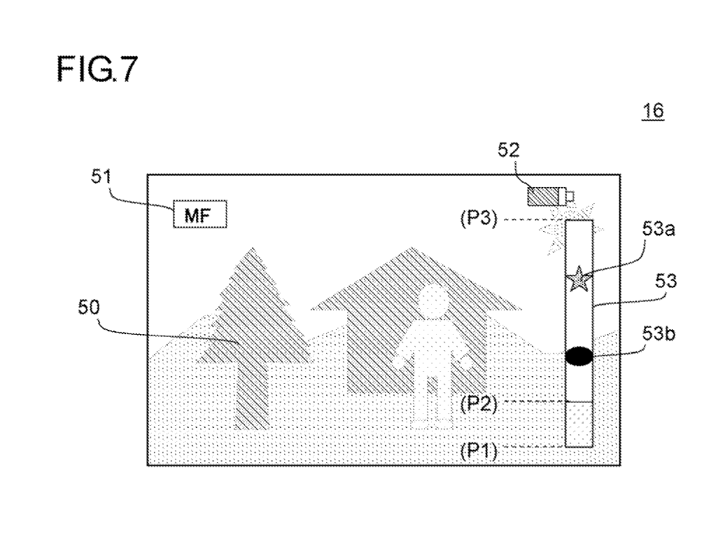

The flow of the replication assistance action will now be described with reference to the flow chart shown in FIG. 6. When the replication assistance action is launched, the control unit 30 displays onscreen a zoom position confirmation bar on the display 16 (step S1). FIG. 7 shows an example of a state in which the zoom position confirmation bar 53 is displayed.

The zoom position confirmation bar 53 has a vertically long rectangular (bar-shaped) profile, and is displayed towards an end of the display 16 so as to minimize the disruption to the visual observability of the monitor image 50. Also, the position on the zoom position confirmation bar 53 in the vertical direction indicates the position of rotation of the zoom ring 13 (where the lower end and the upper end respectively corresponds to P1 and P3 mentioned earlier).

In a portion of the zoom position confirmation bar 53 that corresponds to the zoom region a portion from P2 to p3), the position in the vertical direction can be seen to indicate the zoom position. The zoom position confirmation bar 53 may also be formed only by the portion corresponding to the zoom region, so that a portion corresponding to the power region (i.e., a portion from P1 to P2) is omitted.

The display of the zoom position confirmation bar 53 includes a replication position mark 53a indicating the replication zoom position, and a current position mark 53b indicating the zoom position at the present time (i.e., the position of rotation of the zoom ring 13 at the present time). The replication position mark 53a is displayed on the basis of information [obtained by] reading the zoom position recorded in the action memory 33. The current position mark 53b is displayed on the AD value at the present time.

The control unit 30, while causing the zoom position confirmation bar 53 to be displayed, starts to accept adjustment of the zoom position (step S2). While adjustment of the zoom position is being accepted, the user can perform a rotating operation on the zoom ring 13 and adjust the zoom position.

While the adjustment of the zoom position is being accepted (while the zoom position is being adjusted), the control unit 30 monitors the AD value, and updates the zoom position confirmation bar 53 to the latest state (step S5) in correspondence with the variation in the zoom position (“Y” in step S3). Specifically, the zoom position confirmation bar 53 is updated so that the current position mark 53b shows the zoom position at the present time in real-time. The accepting of the adjustment of the zoom position is continued until the present round of the adjustment of the zoom position is complete (step S4, step S2a). When a user or other operator performs an operation to issue a command to cancel the accepting of the zoom position adjustment (“Y” in step S2b), the zoom position confirmation bar 53 is removed from the display (step S9), and the replication assistance action is discontinued.

The zoom position confirmation bar 53 indicates the replication zoom position and the zoom position at the present time (i.e., during adjustment), and thereby indicates the deviation of the zoom position at the present time from the replication zoom position in real-time. Therefore, the user can look at the zoom position confirmation bar 53 and thereby identify, in addition to the replication zoom position and the zoom position at the present time, the deviation of the zoom position at the present time from the replication zoom position.

The user can then perform a rotating operation on the zoom ring 13 so that the zoom position approaches the desired state while looking at the monitor screen of the subject and the zoom position confirmation bar 53, and adjust the zoom position. Also, when attempting to adjust the zoom position so as to match the replication zoom position (i.e., so that the deviation becomes zero), the user can look at the zoom position confirmation bar 53 and thereby recognize the direction towards which the zoom ring 13 is to be turned.

A variety of formats are possible with regards to the condition in which the adjustment of the zoom position is considered complete (i.e., the zoom position in the present round has been established). For example, the adjustment of the zoom position can be considered complete when the rotation of the zoom ring 13 has stopped for a predetermined time (e.g., 1 second), or the adjustment of the zoom position can be considered complete when a predetermined operation switch 17 has been operated.

When the adjustment of the zoom position is complete (“Y” in step S4), the control unit 30 determines whether or not the zoom position that has been adjusted in the present round matches the replication zoom position (step S6). The term “match” used here is not necessarily limited to “match” in the strict sense, and may include an instance in which there is a relatively small difference between the two (i.e., a substantial match).

When it has been determined that there is a match (“Y” in step S6), the control unit 30 controls the focus adjustment mechanism 32 on the basis of the replication focus position recorded in the action memory 33, and automatically adjusts the focus position to the replication focus position (step S7). Specifically, the control unit 30 sets the focus position to the replication focus position without requiring the user to perform a focus adjustment operation.

At this stage, the current zoom position and focus position are the replication zoom position and the replication focus position, respectively. Specifically, a state to which adjustment has previously taken place has been replicated in relation to the zoom position and the focus position. After the action of step S7 has been performed, the display 16 displays [an indication] that the replication has been performed (i.e., information for notifying the user that [the replication has been performed]) (step S8), the zoom position confirmation bar 53 is removed from the display (step S9), and the replication assistance action is discontinued. After the replication assistance action is discontinued, the action format of the camera 1 shifts to the normal action format when ME is enabled.

In contrast, when it is determined that the adjusted zoom position does not match the replication zoom position (“N” in step S6), the control unit 30 again accepts the adjustment of the zoom position (step S2a).

The replication assistance action mentioned above being performed makes it possible for the user to readily replicate the zoom position and the focus position that have been previously adjusted when, e.g., the power of the camera 1 is [switched] off and then [switched] back on.

Specifically, even when the user has adjusted the zoom position and the focus position, when the zoom ring 13 is rotatably operated to the power region in order to [switch] off the power of the camera 1, the adjusted state is lost. Therefore, in an instance in which an image is to be captured in the adjusted state the next time the power is [switched] on, it is necessary to replicate this state.

Here, the user is not required to adjust the focus position, and can replicate the state merely by adjusting the zoom position so as to match the replication zoom position. Also, since the user can refer to the zoom position confirmation bar 53 when adjusting the zoom position, the zoom position can be readily adjusted so as to match the replication zoom position.

(Other)

As described above, the camera 1 according to the present embodiment comprises an optical system for capturing an image of a subject, and the zoom position and the focus position are adjusted by an adjusting operation performed by the user. The camera 1 further comprises a functional unit (replication information holding unit) for recording and holding the zoom position and the focus position that have been adjusted by the adjustment operation as a replication zoom position and a replication focus position respectively; and a functional unit (replication assistance unit) for assisting the replication of the zoom position and the focus position; the replication assistance unit being configured to automatically adjust the focus position to the replication focus position when the zoom position is adjusted by the adjustment operation so as to match the replication zoom position.

Therefore, the camera 1 does not require a mechanism for automatically replicating the zoom position, and the zoom position and the focus position can be readily replicated. Also, the replication assistance unit displays (i.e., notifies the user of) the zoom position confirmation bar 53 (deviation information) indicating the deviation of the zoom position at the present time from the replication zoom position while the zoom position is adjusted by the adjustment operation.

Therefore, the user can readily perform the adjustment operation to adjust the zoom position so as to match the replication zoom position. The zoom position confirmation bar 53 indicates each of the replication zoom position and the zoom position at the present time, and thereby shows the deviation of the zoom position at the present time from the replication zoom position. With regards to the format for notifying the user with the deviation information, it is possible to employ, other than the format in which the deviation information is displayed as displayed information as with the present embodiment, e.g., a format in which the deviation information is outputted as audio information.

According to the camera of the present invention, the zoom position and the focus position can be readily replicated without the need for a mechanism for automatically replicating the zoom position. In addition to the above-mentioned embodiment, a variety of modifications can be performed on the configuration of the present invention without departing from the spirit of the present invention. Specifically, the embodiment shall be construed in every sense to have been given by way of example, and not by way of limitation. The technical scope of the present invention is indicated not by the description of the above-mentioned embodiment but by the claims, and should be understood to encompass all modifications within the import and scope equivalent to that of the claims.

What is claimed is:

1. A camera, comprising an optical system which captures an image of a subject, in which a zoom position and a focus position are adjusted by an adjustment operation performed by a user; the camera comprising a replication information holding unit which records and holds the zoom position and the focus position adjusted by the adjustment operation as a replication zoom position and a replication focus position respectively; and a replication assistance unit which assists replication of the zoom position and the focus position; the replication assistance unit being configured so as to automatically adjust the focus position to the replication focus position when the zoom position is adjusted by the adjustment operation so as to substantially match the replication zoom position.

2. The camera according to claim 1, the replication assistance unit performing, while the zoom position is adjusted by the adjustment operation, a notification of deviation information indicating a deviation of the zoom position at the present time from the replication zoom position.

3. The camera according to claim 2, the deviation information indicating each of the replication zoom position and the zoom position at the present time, and thereby indicating the deviation.

4. The camera according to claim 3, the replication information holding unit updating the replication zoom position each time the zoom position is adjusted by the adjustment operation, and updating the replication focus position each time the focus position is adjusted by the adjustment operation.

5. The camera according to claim 1 comprising a manual zoom lens, the zoom position being adjusted by performing a rotating operation of a zoom ring.

6. The camera according to claim 2 comprising a manual zoom lens, the zoom position being adjusted by performing a rotating operation of a zoom ring.

7. The camera according to claim 3 comprising a manual zoom lens, the zoom position being adjusted by performing a rotating operation of a zoom ring.

8. The camera according to claim 4 comprising a manual zoom lens, the zoom position being adjusted by performing a rotating operation of a zoom ring.

9. The camera according to claim 5, a first region and a second region being provided adjacently in a region of the zoom ring allowing movement in a rotation direction;
a power-on state being maintained and the zoom position adjusted by the rotating operation when the position of rotation of the zoom ring is in the first region;
a power-off state being maintained when the position of rotation of the zoom ring is in a power-off region provided within the second region; and
the replication information holding unit holding the replication zoom position and the replication focus position even in the power-off state.

10. The camera according to claim 6,
a first region and a second region being provided adjacently in a region of the zoom ring allowing movement in a rotation direction;
a power-on state being maintained and the zoom position adjusted by the rotating operation when the position of rotation of the zoom ring is in the first region;
a power-off state being maintained when the position of rotation of the zoom ring is in a power-off region provided within the second region; and
the replication information holding unit holding the replication zoom position and the replication focus position even in the power-off state.

11. The camera according to claim 7,
a first region and a second region being provided adjacently in a region of the zoom ring allowing movement in a rotation direction;
a power-on state being maintained and the zoom position adjusted by the rotating operation when the position of rotation of the zoom ring is in the first region;
a power-off state being maintained when the position of rotation of the zoom ring is in a power-off region provided within the second region; and
the replication information holding unit holding the replication zoom position and the replication focus position even in the power-off state.

12. The camera according to claim 8,
a first region and a second region being provided adjacently in a region of the zoom ring allowing movement in a rotation direction;
a power-on state being maintained and the zoom position adjusted by the rotating operation when the position of rotation of the zoom ring is in the first region;
a power-off state being maintained when the position of rotation of the zoom ring is in a power-off region provided within the second region; and
the replication information holding unit holding the replication zoom position and the replication focus position even in the power-off state.
